(19) United States
(12) Patent Application Publication
(10) Pub. No.: US 2012/0237901 A1
(43) Pub. Date: Sep. 20, 2012

(54) Denture Adhesive Remover for Intraoral and Extraoral Use

(76) Inventors: Kristine A. White, North Branford, CT (US); Richard J. Panagrossi, JR., Branford, CT (US)

(21) Appl. No.: 13/423,690

(22) Filed: Mar. 19, 2012

Related U.S. Application Data
(60) Provisional application No. 61/465,314, filed on Mar. 17, 2011.

(51) Int. Cl. A61C 13/23

(52) U.S. Cl. 433/180

(57) ABSTRACT

Described herein are all-natural compositions and methods of using them for removing denture adhesive from both the denture apparatus and the oral cavity. The compositions comprise acetic acid and water. The invention includes wipes premoistened with a composition of the invention.

### RELATED APPLICATIONS

This application claims the benefit of priority to U.S. Provisional Patent Application Ser. No. 61/465,314, filed Mar. 17, 2011, the contents of which are hereby incorporated by reference.

### BACKGROUND

There are millions of denture-wearers in the United States and around the world. From a purely functional standpoint, a removable dental prosthesis (“denture”) provides a means of mastication of food for a patient who is either partially or fully edentulous. There are two types of conventional tissue-supported dentures: partial and complete. Conventional removable dentures of either type rely on natural abutments or tissues for support and retention, unlike implant-supported removable devices, which are supported and retained by titanium structures surgically placed in a patient's jaw bone.

A removable partial denture is retained in its intended position in the oral cavity by clasps or rests, which engage the remaining natural teeth and provide support for the denture base. By physically “latching-onto” the remaining teeth, the denture can maintain stability and be accurately positioned. It is important that the denture remain in position during the mastication process and during the actions of speaking, laughing, kissing, and smiling. A removable partial denture affords the partially-edentulous patient with a means of complementing his or her remaining natural teeth.

A removable complete denture is retained in its intended position in the oral cavity solely by the degree to which the prosthesis adapts to the patient's oral anatomy; it is fully tissue-supported. A complete denture, usually constructed of acrylic or acrylic with a metal reinforcement substructure, is fabricated following the extraction of all remaining natural teeth. Additional surgical procedures may be necessary prior to the construction of the prosthesis, in order to enhance its adaptation to the physical anatomy of the patient's oral cavity. A patient may require a complete denture due to compromised physical anatomy resulting from trauma, disease or genetic predisposition. Ultimately, however, the goal is to provide the fully edentulous patient with a comfortable, functional and retentive prosthetic replacement for the lost teeth.

Retention is the key factor in determining the overall reliability and effectiveness of the denture. Effective retention of the denture is, or is not, established at the interface of the interior or underside of the denture base and the patient's anatomic ridge or palatal vault. In simple terms, if the appliance does not stay in place, its usefulness is called into question. Even when the complete denture is well-fitting and retentive, it will provide a patient with a chewing efficiency of about one-third of that which is achieved with the natural dentition. A well-fitting denture must remain secure in a patient's mouth and be comfortable in order for it to be deemed useful.

Denture adhesives are used by a patient to help secure a removable dental prosthesis in its position. Adhesives may be used by a patient with an ill-fitting prosthesis, or by one who simply wishes to have an additional degree of retention for an otherwise well-fitting and comfortable prosthesis. Additionally, denture adhesives may be used by a patient to afford a more comfortable fit by acting as a cushion between the tissue-bearing aspect of the appliance and the tissue itself. Denture adhesive is used, in varying amounts, on at least a once-daily basis; it may be used more frequently, depending on the duration of its effectiveness for any one given application. At the end of each day, the used adhesive must be cleaned from the oral cavity as well as from the denture. Ideally, the used adhesive must be removed in its entirety prior to any subsequent re-application of fresh adhesive. However, the used adhesive is very difficult to remove; removal of the used adhesive is, at best, a tedious and frustrating task.

Brushes and other scraping devices that require the denture wearer to physically remove the denture adhesive from the denture by wiping and scrubbing are known. See U.S. Pat. No. 5,032,082 to Herrara; U.S. Pat. No. 5,261,817 to Nack; and U.S. Pat. No. 5,987,689 to Gordon; all of which are incorporated by reference. Such devices may cause irritation when used directly on the soft oral tissues. Brush heads may be too large and unyielding to effectively access all areas of the denture plate. In addition, these devices can be bulky and difficult to conceal, thus, making discrete, portable and convenient removal of denture adhesive and denture adhesive residue difficult.

Other recommendations for the removal of denture adhesive from the oral cavity include (a) using a cloth dampened with warm water to wipe out the excess or remaining adhesive, and (b) taking water into the mouth, as hot as the patient can tolerate (without causing undue trauma), which then affects a “melting” of the used adhesive, which in turn, makes the adhesive easier to wipe away. These methods usually are employed multiple times in order to approach any modicum of success.

There exists a need for a safe, effective, reliable method of removing denture adhesive from the mouth as well as from the denture.

### SUMMARY OF THE INVENTION

In certain embodiments, the invention relates to a method comprising the steps of

contacting with the oral cavity of a patient in need thereof with an effective amount of a composition for a first period of time, wherein the oral cavity comprises an adhesive, thereby substantially removing or substantially dissolving the adhesive from the oral cavity.

In certain embodiments, the invention relates to any one of the aforementioned methods, wherein the composition comprises water; and acetic acid.

In certain embodiments, the invention relates to any one of the aforementioned methods, wherein the acetic acid is in the form of vinegar; and the vinegar is white vinegar. In certain embodiments, the invention relates to any one of the aforementioned methods, wherein the vinegar is distilled white vinegar.

In certain embodiments, the invention relates to any one of the aforementioned methods, wherein the concentration of acetic acid is from about 0.5% to about 4% by weight of the composition.

In certain embodiments, the invention relates to any one of the aforementioned methods, wherein the composition further comprises a flavoring agent.

In certain embodiments, the invention relates to any one of the aforementioned methods, wherein the effective amount of the composition is from about 0.5 oz. to about 3.0 oz.

In certain embodiments, the invention relates to any one of the aforementioned methods, further comprising the step of

removing a denture from the oral cavity of a patient in need thereof, wherein the denture was secured by an adhesive.

In certain embodiments, the invention relates to any one of the aforementioned methods, wherein the first period of time is from about 10 s to about 1 min.

In certain embodiments, the invention relates to any one of the aforementioned methods, further comprising the step of

expectorating the composition from the oral cavity after the period of time.

### DETAILED DESCRIPTION OF THE INVENTION

### Overview

In certain embodiments, the invention relates to a composition that facilitates removal of denture adhesive, which is an otherwise difficult, incomplete, and tedious task, at best. In certain embodiments, the composition breaks down the key ingredients in denture adhesives, cellulose gum and the polymethylvinyl ether. In certain embodiments, breaking the adherent property is crucial to removing denture adhesive.

In certain embodiments, the invention relates to a method of removing or dissolving a denture adhesive. In certain embodiments, the method relates to a safe, easy, and reliable means of addressing this burdensome task.

### Definitions

For convenience, certain terms employed in the specification and appended claims are collected here. These definitions should be read in light of the entire disclosure and understood as by a person of skill in the art.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The phrase “or,” as used herein in the specification and in the claims, should be understood to mean “either or both” of the elements so conjoined, i.e., elements that are conjunctively present in some cases and disjunctively present in other cases. Multiple elements listed with “or” should be construed in the same fashion, i.e., “one or more” of the elements so conjoined. Other elements may optionally be present other than the elements specifically identified by the “or” clause, whether related or unrelated to those elements specifically identified. Thus, as a non-limiting example, a reference to “A or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The term “denture(s)”, as used herein, is meant to include full and partial dentures, dental plates, bridges, artificial teeth and other hard surfaces of dental appliances which are temporarily fixed within the oral cavity and which are typically removed from the oral cavity for cleaning

The phrase “natural surfaces of the oral cavity” as used herein is meant to include teeth, gums, palate, tongue or any other natural surface of the oral cavity that may be exposed to denture adhesives.

### Exemplary Constituents of Compositions of the Invention

Exemplary identities of various constituents of the compositions of the present invention are described below.

### 1. Vehicles

Suitable vehicle components for use with the formulations or compositions of the invention are well known in the cosmetic and pharmaceutical arts, and include such vehicles (or vehicle components) as water; organic solvents such as alcohols (particularly lower alcohols readily capable of evaporating from the skin such as ethanol), glycols (such as propylene glycol, butylene glycol, and glycerol (glycerin)), aliphatic alcohols (such as lanolin); mixtures of water and organic solvents (such as water and alcohol), and mixtures of organic solvents such as alcohol and glycerol (optionally also with water); and other vehicles and vehicle components that are suitable for administration to the skin, as well as mixtures of vehicle components as identified above or otherwise known to the art.

In one embodiment, the compositions of the present invention are aqueous solutions. Liquids suitable for use in formulating compositions of the present invention include water, and water-miscible solvents such as glycols (e.g., ethylene glycol, butylene glycol, isoprene glycol, propylene glycol), glycerol, liquid polyols, and isopropyl alcohol. One or more aqueous vehicles may be present.

### 2. Acetic Acid

Acetic acid is a colorless liquid that has a distinctive sour taste and pungent smell. Aside from water, acetic acid is the main component of vinegar. Although it is classified as a weak acid, concentrated acetic acid is corrosive.

Dilute solutions of acetic acid in water are used as household cleaning agents and reportedly have strong antibacterial properties. For example, a 5% solution is 90% effective against mold and 99.9% effective against bacteria.

Acetic acid is also environmentally-friendly.

### 3. Preservatives and Antioxidants

The composition may further include components adapted to improve the stability or effectiveness of the applied formulation.

Suitable preservatives for use in the present invention include, but are not limited to: ureas, such as imidazolidinyl urea and diazolidinyl urea; phenoxyethanol; sodium methyl paraben, methylparaben, ethylparaben, and propylparaben; potassium sorbate; sodium benzoate; sorbic acid; benzoic acid; formaldehyde; citric acid; sodium citrate; chlorine dioxide; quaternary ammonium compounds, such as benzalkonium chloride, benzethonium chloride, cetrimide, dequalinium chloride, and cetylpyridinium chloride; mercurial agents, such as phenylmercuric nitrate, phenylmercuric acetate, and thimerosal; piroctone olamine; Vitis vinifera seed oil; and alcoholic agents, for example, chlorobutanol, dichlorobenzyl alcohol, phenylethyl alcohol, and benzyl alcohol.

Suitable antioxidants include, but are not limited to, ascorbic acid and its esters, sodium bisulfite, butylated hydroxytoluene, butylated hydroxyanisole, tocopherols (such as α-tocopherol), tocopheryl acetate, sodium ascorbate/ascorbic acid, ascorbyl palmitate, propyl gallate, and chelating agents like EDTA (e.g., disodium EDTA), citric acid, and sodium citrate.

In addition, combinations or mixtures of these preservatives or anti-oxidants may also be used in the formulations of the present invention.

### 4. Viscosity Modifiers

Suitable viscosity adjusting agents (i.e., thickening and thinning agents) for use in the formulations of the present invention include, but are not limited to, protective colloids or non-ionic gums such as hydroxyethylcellulose, xanthan gum, and sclerotium gum, as well as magnesium aluminum silicate, silica, microcrystalline wax, beeswax, paraffin, and cetyl palmitate. In addition, appropriate combinations or mixtures of these viscosity adjusters may be utilized according to the present invention.

### 5. Additional Constituents

Additional constituents suitable for incorporation into the compositions of the present invention include, but are not limited to: skin protectants, adsorbents, demulcents, emollients, moisturizers, sustained release materials, solubilizing agents, skin soothing agents, vitamins, anti-irritants, absorbents, binders/excipients, chelating agents, conditioning agents, opacifying agents, immunomodulators, and pH adjusters.

Examples of skin soothing agents include, but are not limited to, allantoin, aloe, avocado oil, green tea extract, hops extract, chamomile extract, colloidal oatmeal, calamine, cucumber extract, and combinations thereof.

Examples of vitamins include, but are not limited to, vitamins A, D, E, K, and combinations thereof. Vitamin analogues are also contemplated.

Suitable fragrances and colorants may be used in the formulations of the present invention. Examples of fragrances and colorants suitable for use in products are known in the art.

Flavorants (flavoring agents) or sweeteners may be incorporated in the compositions of the present invention. Flavorants and sweeteners are typically present from about 0.1% to about 5% by weight of the composition. Suitable flavoring agents include, but are not limited to, essential oils such as methyl salicylate, anise, anethol, bergamot, camphor, cinnaminic anhydrides, clove, eucalyptol, peppermint, spearmint, and thyme.

The compositions of the present invention may optionally further comprise one or more cosmetic or therapeutic active agents where, upon directed use, the benefit sought by the wearer is promoted without detriment to the oral cavity. Examples of the conditions these active agents may address include, but are not limited to, appearance and structural changes to teeth, treatment and prevention of plaque, calculus, cavities in remaining natural teeth, inflamed and/or bleeding gums, gingivitis, fungal infections such as those associated with candida albicans, mucosal wounds, lesions, ulcers, aphthous ulcers, cold sores, tooth abscesses, and the elimination of mouth malodor resulting from the conditions above and other causes such as microbial proliferation. Suitable cosmetic or therapeutic active agents include any material that is generally considered safe for use in the oral cavity. The cosmetic and therapeutic actives may be selected from the group consisting of anti-calculus agents; anti-caries agents such as fluoride ion sources; stannous ion sources; tooth whitening agents; breath fresheners; anti-plaque agents; anti-inflammatory agents; nutrients; antioxidants; analgesic agents; local anesthetic agents; antihistamines; disinfectants; vasoconstrictors; hemostatics; chemotherapeutics; antibiotics; tooth desensitizing agents; vasodilators; antihyperstensives; antiemetics; antimigraine; antiarrhythmics; antiasthmatics; antidepressants; vaccines; peptides or prodrugs; hormones; proton pump inhibitors; and H2 receptor antagonists.

Additional suitable classes of active agents include, but are not limited to, antibiotic agents, antimicrobial agents, antibacterial agents, antifungal agents, antiviral agents, steroidal anti-inflammatory agents, non-steroidal anti-inflammatory agents, anesthetic agents, antiprotozoal agents, anti-oxidants, and vitamins. Mixtures of any of these active agents may also be employed. Additionally, pharmaceutically-acceptable salts and esters of any of these agents may be employed.

Other optional ingredients that may be incorporated into the compositions of the present invention include sensates; pigments; dyes; and mixtures thereof.

### Exemplary Compositions

In certain embodiments, the invention relates to a composition, wherein the composition comprises water; and acetic acid.

In certain embodiments, the invention relates to a composition, wherein the composition consists essentially of water; and acetic acid.

In certain embodiments, the invention relates to a composition, wherein the composition consists of water; and acetic acid.

In certain embodiments, the invention relates to any one of the aforementioned compositions, wherein the water is distilled water.

In certain embodiments, the invention relates to any one of the aforementioned compositions, wherein the acetic acid is in the form of vinegar.

In certain embodiments, the invention relates to any one of the aforementioned compositions, wherein the vinegar is selected from the group consisting of white vinegar, malt vinegar, wine vinegar, sherry vinegar, apple cider vinegar, fruit vinegar, rice vinegar, coconut vinegar, palm vinegar, cane vinegar, and honey vinegar.

In certain embodiments, the invention relates to any one of the aforementioned compositions, wherein the vinegar is white vinegar.

In certain embodiments, the invention relates to any one of the aforementioned compositions, wherein the vinegar is distilled vinegar.

In certain embodiments, the invention relates to any one of the aforementioned compositions, wherein the vinegar is distilled white vinegar.

In certain embodiments, the invention relates to any one of the aforementioned compositions, wherein the concentration of acetic acid is from about 0.5% to about 4% by weight of the composition. In certain embodiments, the invention relates to any one of the aforementioned compositions, wherein the concentration of acetic acid is about 0.5%, about 1.0%, about 1.5%, about 2.0%, about 2.5%, about 3.0%, about 3.5%, or about 4.0% by weight of the composition.

In certain embodiments, the invention relates to any one of the aforementioned compositions, wherein the composition further comprises a flavoring agent.

In certain embodiments, the invention relates to any one of the aforementioned compositions, wherein the flavoring agent is selected from the group consisting of methyl salicylate, anise, anethol, bergamot, camphor, cinnaminic anhydrides, clove, eucalyptol, peppermint, spearmint, and thyme

In certain embodiments, the invention relaters to any one of the aforementioned compositions, wherein the composition further comprises a colorant.

In certain embodiments, the invention relates to any one of the aforementioned compositions, wherein the composition is substantially translucent. In certain embodiments, the tion relates to any one of the aforementioned compositions, wherein the composition substantially translucent blue. In certain embodiments, the invention relates to any one of the aforementioned compositions, wherein the composition substantially translucent green.

### Exemplary Articles

In certain embodiments, the invention relates to an article comprising any one of the aforementioned compositions. In certain embodiments, the invention relates to an article comprising an effective amount of any one of the aforementioned compositions.

In certain embodiments, the article is a wipe, wherein the wipe comprises any one of the aforementioned compositions. In certain embodiments, the article is a wipe, wherein the wipe comprises an effective amount of any one of the aforementioned compositions. In certain embodiments, the wipe is premoistened with any one of the aforementioned compositions.

In certain embodiments, wipes are premoistened, disposable towelettes that are utilized in a variety of applications both domestic and industrial and perform a variety of functions. In certain embodiments, wipes are used to wipe surfaces both animate and inanimate, and may provide numerous benefits such as cleaning, cleansing, and disinfecting. In certain embodiments, wipes are used for wiping parts of the human body, particularly when wash water is not available, for example when travelling. In certain embodiments, wipes are commonly used for human cleansing and wiping. In certain embodiments, wipes may also be used for application of substances to the body.

In certain embodiments, the invention relates to a wipe, wherein the wipe comprises a flexible substrate; and the flexible substrate is coated or impregnated with any one of the aforementioned compositions. In certain embodiments, the flexible substrate is woven or nonwoven, foam, sponge, battings, balls, puffs or films. In certain embodiments, the flexible substrate comprises natural or synthetic fibers or mixtures thereof. In certain embodiments, the fibers of the flexible substrate are a mixed of hydrophilic fiber material, such as viscose, cotton, or flax, and a hydrophobic fiber material, such as polyethylene terephthalate (PET) or polypropylene (PP) in a ratio of about 20% to about 80% hydrophilic and about 80% to about 20% hydrophobic material by weight. In certain embodiments, the flexible substrate has any thickness suitable for the intended use.

### Exemplary Properties of Compositions and Articles

In certain embodiments, the invention relates to any one of the aforementioned compositions, wherein the composition is all-natural.

In certain embodiments, the invention relates to any one of the aforementioned compositions or articles, wherein the composition or article is safe for oral use.

In certain embodiments, the invention relates to any one of the aforementioned compositions or articles, wherein the composition or article is inexpensive to manufacture.

In certain embodiments, the invention relates to any one of the aforementioned compositions or articles that, upon use in the oral cavity or on the denture of an affected subject, is non-irritating.

In certain embodiments, the invention relates to any one of the aforementioned compositions or articles that, upon use in the oral cavity or on the denture of an affected subject, is well-tolerated.

In certain embodiments, the invention relates to any one of the aforementioned compositions or articles that, upon use in the oral cavity or on the denture of an affected subject, is non-cytotoxic.

In certain embodiments, the invention relates to any one of the aforementioned compositions or articles that, upon use in the oral cavity or on the denture of an affected subject, is weakly sensitizing. In certain embodiments, the invention relates to any one of the aforementioned compositions or articles that, upon use in the oral cavity or on the denture of an affected subject, is non-sensitizing.

### Exemplary Compositions and Articles for Particular Uses

In certain embodiments, the invention relates to any one of the aforementioned compositions or articles for use in the removal or dissolution of an adhesive.

In certain embodiments, the composition or article is used to remove or dissolve the adhesive from the oral cavity of a patient in need thereof.

In certain embodiments, the composition or article is used to remove or dissolve the adhesive from a denture.

In certain embodiments, the composition or article is formulated for use once daily, twice daily, three times daily, or four times daily.

### Exemplary Kits

In certain embodiments, the invention relates to a kit comprising

any one of the aforementioned compositions; and

instructions for use.

In certain embodiments, the invention relates to a kit comprising

any one of the aforementioned articles; and

instructions for use.

### Exemplary Methods of Use

In certain embodiments, the invention relates to a method comprising the steps of

contacting with the oral cavity of a patient in need thereof with an effective amount of any one of the aforementioned compositions for a first period of time, wherein the oral cavity comprises an adhesive, thereby substantially removing or substantially dissolving the adhesive from the oral cavity.

In certain embodiments, the invention relates to any one of the aforementioned methods, wherein the effective amount of the composition is from about 0.5 oz. to about 3.0 oz. In certain embodiments, the invention relates to any one of the aforementioned methods, wherein the effective amount of the composition is about 0.5 oz., about 1.0 oz., about 1.5 oz., about 2.0 oz., about 2.5 oz, or about 3.0 oz.

In certain embodiments, the invention relates to any one of the aforementioned methods, further comprising the step of

removing a denture from the oral cavity of a patient in need thereof, wherein the denture was secured by an adhesive.

In certain embodiments, the invention relates to any one of the aforementioned methods, wherein the first period of time is from about 10 s to about 1 min. In certain embodiments, the invention relates to any one of the aforementioned methods, wherein the first period of time is about 10 s, about 20 s, about 30 s, about 40 s, about 50 s, or about 1 min.

In certain embodiments, the invention relates to any one of the aforemetioned methods, further comprising the step of

expectorating the composition from the oral cavity after the period of time.

In certain embodiments, the invention relates to any one of the aforementioned methods, further comprising the steps of

expectorating the composition from he oral cavity after the period of e; and

contacting with the oral cavity of a patient in need thereof with a second effective amount of any one of the aforementioned compositions for a second period of time, wherein the oral cavity comprises an adhesive, thereby substantially removing or substantially dissolving the adhesive from the oral cavity.

In certain embodiments, the invention relates to any one of the aforementioned methods, wherein the oral cavity is contacted with the composition once a day, twice a day, three times a day, or four times a day.

In certain embodiments, the invention relates to any one of the aforementioned methods, wherein the oral cavity is contacted with the composition every time the denture is removed from the oral cavity.

In certain embodiments, the invention elates to a method comprising the steps of

wiping the oral cavity of a patient in need thereof with any one of the aforementioned articles, wherein the oral cavity comprises an adhesive, thereby substantially removing or substantially dissolving the adhesive from the oral cavity.

In certain embodiments, the invention relates to any one of the aforementioned methods, wherein the article comprises an effective amount of any one of the aforementioned compositions.

In certain embodiments, the invention relates to any one of the aforementioned methods, wherein the article is a wipe; and the wipe comprises any one of the aforementioned compositions. In certain embodiments, the invention relates to any one of the aforementioned methods, wherein the article is a wipe; and the wipe comprises an effective amount of any one of the aforementioned compositions. In certain embodiments, the invention relates to any one of the aforementioned methods, wherein the wipe is premoistened with an effective amount of any one of the aforementioned compositions.

In certain embodiments, the invention relates to any one of the aforementioned methods, wherein the wipe is disposable.

In certain embodiments, the invention relates to any one of he aforementioned methods, further comprising the step of

removing a denture from the oral cavity of a patient in need thereof, wherein the denture was secured by an adhesive.

In certain embodiments, the invention relates to any one of the aforementioned methods, wherein oral cavity is contacted with the article once a day, twice a day, three times a day, or four times a day.

In certain embodiments, the invention relates to any one of the aforementioned methods,

wherein the oral cavity is contacted with the article every time the denture is removed from the oral cavity.

In certain embodiments, the invention relates to a method comprising the steps of

contacting with a denture an effective amount of any one of the aforementioned compositions for a second period of time, wherein the denture comprises an adhesive, thereby substantially removing or substantially dissolving the adhesive from the denture.

In certain embodiments, the invention relates to any one of the aforementioned methods, wherein the composition is placed into the interior aspect of the denture for the second period of time.

In certain embodiments, the invention relates to any one of the aforementioned methods, wherein the second period of time is from about 20 s to about 3 min. In certain embodiments, the invention relates to any one of the aforementioned methods, wherein the second period of time is about 20 s, about 30 s, about 40 s, about 50 s, about 1 min, about 70 s, about 80 s, about 90 s, about 100 s, about 110 s, about 2 min, about 130 s, about 140 s, about 150 s, about 160 s, about 170 s, or about 3 min.

In certain embodiments, the invention relates to any one of the aforementioned methods, further comprising the steps of

removing the composition from the denture; and

wiping the denture, thereby substantially removing or substantially dissolving the adhesive from the denture.

In certain embodiments, the invention relates o any one of the aforementioned methods, wherein the denture is wiped with a cloth or wipe.

In certain embodiments, the invention relates to any one of the aforementioned methods, further comprising the step of

removing a denture from the oral cavity of a patient in need thereof, wherein the denture was secured by an adhesive.

In certain embodiments, the invention relates to any one of the aforementioned methods, wherein the method is practiced alone or in combination with an applicator or other system for removing denture adhesive.

### INCORPORATION BY REFERENCE

All of the U.S. patents and U.S. published patent applications cited herein are hereby incorporated by reference.

### EQUIVALENTS

Those skilled in the art will recognize, or be able to ascertain using no more than routine experimentation, many equivalents to the specific embodiments of the invention described herein. Such equivalents are intended to be encompassed by the following claims.

We claim:

1. A method comprising the steps of
contacting with the oral cavity of a patient in need thereof with an effective amount of a composition for a first period of time, wherein the oral cavity comprises an adhesive, thereby substantially removing or substantially dissolving the adhesive from the oral cavity.

2. The method of claim 1, wherein the composition comprises water, and acetic acid,

3. The method of claim 2, wherein the water is distilled water.

4. The method of claim 2, wherein the acetic acid is in the form of vinegar.

5. The method of claim 4, wherein the vinegar is selected from the group consisting of white vinegar, malt vinegar, wine vinegar, sherry vinegar, apple cider vinegar, fruit negar, rice vinegar, coconut vinegar, palm vinegar, cane vinegar, and honey vinegar.

6. The method of claim 4, wherein the vinegar is white vinegar.

7. The method of claim 4, wherein the vinegar is distilled vinegar.

8. The method of claim 4, wherein the vinegar s distilled white vinegar.

9. The method of claim 2, wherein the concentration of acetic acid is from about 0.5% to about 4% by weight of the composition.

10. The method of claim 2, wherein the composition further comprises a flavoring agent.

11. The method of claim 2, wherein the composition further comprises a colorant.

12. The method of claim 2 wherein the effective amount of the composition is from about 0.5 oz, to about 3.0 oz.

13. The method of claim 2, wherein the effective amount of the composition is about 0.5 oz., about 1.0 oz., about 1.5 oz., about 2.0 oz., about 2.5 oz., or about 3.0 oz.

14. The method of claim 2, further comprising the step of
removing a denture from the oral cavity of a patient in need thereof, wherein the denture was secured by an adhesive.

15. The method of claim 2, wherein the first period of time is from about 10 s to about 1 min.

16. The method of claim 2, wherein the first period of time is about 10 s, about 20 s, about 30 s, about 40 s, about 50 s, or about 1 min.

17. The method of claim 2, further comprising the step of
expectorating the composition from the oral cavity after the period of time.

18. The method of claim 2, further comprising the steps of
expectorating the composition from the oral cavity after the period of time; and
contacting with the oral cavity of a patient in need thereof with a second effective amount of a composition for a second period of time, wherein the oral cavity comprises an adhesive, thereby substantially removing or substantially dissolving the adhesive from the oral cavity.

19. The method of claim 2, wherein the oral cavity is contacted with the composition once a day, twice a day, three times a day, or four times a day.

20. The method of claim 2, wherein the oral cavity is contacted with the composition every time the denture is removed from the oral cavity.
